(19) United States
(12) Patent Application Publication
(10) Pub. No.: US 2012/0233838 A1
(43) Pub. Date: Sep. 20, 2012

(54) METHOD AND APPARATUS FOR INCREASING AND ADJUSTING DISTRIBUTION OF WEIGHT WITHIN A GOLF CLUB HEAD

(76) Inventor: Jason Swist, Edmonton (CA)

(21) Appl. No.: 13/417,605

(22) Filed: Mar. 12, 2012

Related U.S. Application Data
(60) Provisional application No. 61/452,196, filed on Mar. 14, 2011.

(51) Int. Cl. B23P 11/00

(52) U.S. Cl. 29/428

(57) ABSTRACT

Every amateur golfer wishes to improve their game. Doing so is usually achieved through significant practice and the hit-and-miss search for the right golf club. Accordingly to embodiments of the invention golf clubs imparting increased driving range through an overall increase in the mass of the golf club are presented. Additional aspects of the invention relate to achieving this without imparting a corresponding reduction in the swing velocity as well as providing for the addition of the mass a manner that reduces the tendency for the golfers swing to change, and allows for adjustment to address their natural tendency to hook or slice. As such the additional mass added to a driver may, according to embodiments of the invention, be compensated by the adjustment in the balance of the golf club and allowing for the additional mass to be added non-uniformly to the golf club head.

### CROSS-REFERENCE TO RELATED APPLICATIONS

This patent application claims the benefit of U.S. Provisional Patent Application U.S. 61/452,196 filed Mar. 14, 2011 entitled “Method and Apparatus for Increasing and Adjusting Distribution of Weight within a Golf Club Head”

### FIELD OF THE INVENTION

This invention relates to golf clubs and more specifically to increasing the mass and adjusting the balance of said clubs.

### BACKGROUND OF THE INVENTION

Golf is a popular game, not only in the United States, but also in many other parts of the world such as Korea, Japan, India, China, Germany, UK and South Africa. Within the last 5 years, the golf industry has seen steady growth of 5-15% annually in most regions of the world. According to a recent market study “Opportunities in the Global Golf Club Market 2004-2009” published by E-Composites, Inc., the golf club market in India and China will continue to see a growth rate of over 25% annually for the period 2010-2014. The growing popularity of the game and the general affluence of golfers ensure a substantial market, which in 2010 was estimated as US $3.9 billion.

The market for manufacturers of golf clubs/golf shafts is crowded with small to large corporations such as Callaway, Taylormade, Acushnet, Ping Golf and Wilson. There are more than 100 manufacturers of golf clubs and golf club shafts around the world and about 50 of these golf club/golf club shaft manufacturers are in the USA alone. The remaining suppliers are mostly based in China, Taiwan, Korea, Japan, UK, and Germany.

Considering Callaway, one of the industry leaders, then in 2008 sales were divided between woods (24%), irons (27.6%), putters (9.1%), balls (20%), and other accessories (19.3%). With annual revenues of US$1,100 million in 2008 and US$950 million in 2009 woods, irons, and putters together accounted for approximately 60% of their revenue, US$1,230 million for the two years.

Over the years golf club manufacturers have released hundreds of new models featuring variations in the design of many elements of the golf clubs including hosel profile, heel, top line, toe, face, back, back cavity, sole, weighting for the head alone together with introducing steel variations, titanium and carbon fiber materials for the shafts, and weight, geometry, and polymeric materials for the grip that slides onto the upper portion of the shaft. Despite the massive research and development efforts, brand profiles built upon world renowned figures over the past decades such as Tiger Woods, Jack Nicklaus, Greg Norman, Seve Ballesteros, and Fred Couples the fundamental assembly of golf clubs has not changed for a century since the Thomas Horsburgh experimented with steel shafts in the late 1890s.

However, the designers of these hundreds of models, as well as the many tens of golf ball designs released over the years, do not have complete freedom in the design, shape, features, and materials of their products. Overall the design of golf clubs, golf balls and the resulting performance of these must meet the rules and regulations of the sport that are controlled by various national organizations, such as the United States Golf Association (USGA), in association with the The Royal and Ancient Golf Course at St Andrews, Scotland.

Consider a golf club manufacturer wishing to market their golf clubs in the United States then they should submit to the USGA a sample of a club to be manufactured for a ruling as to whether the club conforms with the Rules or not. Further, where a club, or part of a club, is required to meet a specification within the Rules, it must be designed and manufactured with the intention of meeting that specification.

With respect to clubs then the rules state it “must not be substantially different from the traditional and customary form and make”. The club must be composed of a shaft and a head and it may also have material added to the shaft to enable the player to obtain a firm hold. All parts of the club must be fixed so that the club is one unit, and it must have no external attachments. Considering golf club heads then these may incorporate mechanisms for weight adjustment and other forms of adjustability may also be permitted upon evaluation by the USGA. However, the club head must not be purposely changed by adjustment or by any other means during playing of a round of golf, and for any permissible method of adjustment it cannot be easily made by the golfer, all adjustable parts must be firmly fixed so that there is no reasonable likelihood of them working loose during a round, and all configurations of adjustment conform with the Rules.

When the golf club is in its normal address position the shaft must be so aligned with the club head so that:
(i) the projection of the straight part of the shaft on to the vertical plane through the toe and heel must diverge from the vertical by at least 10 degrees. If the overall design of the club is such that the player can effectively use the club in a vertical or close-to-vertical position, the shaft may be required to diverge from the vertical in this plane by as much as 25 degrees;
(ii) the projection of the straight part of the shaft on to the vertical plane along the intended line of play must not diverge from the vertical by more than 20 degrees forward or 10 degrees backward.

Except for putters, all of the heel portion of the club head must lie within 0.625 inches (15.88 mm) of the plane containing the axis of the straight part of the shaft and the intended (horizontal) line of play.

The club head must be generally plain in shape and all its parts must be rigid, structural in nature and functional. The club head or its parts must not be designed to resemble any other object. It is not practicable to define plain in shape precisely and comprehensively. However, features which are deemed to be in breach of this general requirement for all and are therefore not permitted include, but are not limited to:
holes through the face or head (some exceptions may be made for putters and cavity back irons);
features that are for the purpose of meeting dimensional specifications;
features that extend into or ahead of the face or extend significantly above the top line of the head;
furrows in or runners on the head that extend into the face; and
optical or electronic devices.

For club heads on woods and irons these inadmissible features additionally include:
cavities in the outline of the heel and/or toe that can be viewed from above;
severe or multiple cavities in the outline of the back that can be viewed from above;
transparent material added to the head with the intention of rendering conforming a feature that is not otherwise permitted; and
features that extend beyond the outline of the head when viewed from above.

Additionally, golf club heads must meet specific requirements in terms of dimensions, volume and moment of inertia. Considering woods then the dimensional requirements, which must be met when the golf club is in a 60 degree lie angle, are that:
the distance from heel to toe is greater than the distance from face to back;
the distance from heel to toe is not greater than 5 inches (127 mm); and
the distance from sole to crown is not greater than 2.8 inches (71.12 mm).

These dimensions are measured, as shown in FIG. 4, on horizontal lines between vertical projections of the outermost points of the heel and the toe, and the face and the back, and on vertical lines between the horizontal projections of the outermost points of the sole and the crown. If the outermost point of the heel is not clearly defined, it is deemed to be 0.875 inches (22.23 mm) above the horizontal plane on which the club is lying.

The volume of the club head must not exceed 460 cubic centimeters (28.06 cubic inches), plus a tolerance of 10 cubic centimeters (0.61 cubic inches). When the club is in a 60-degree lie angle, the moment of inertia component around the vertical axis through the club head's center of gravity must not exceed 5900 g cm (32.259 oz in), plus a test tolerance of 100 g cm (0.547 oz in).

For irons, when the club head is in its normal address position, the dimensions of the head must be such that the distance from the heel to the toe is greater than the distance from the face to the back Likewise, there are dimensional rules for putters as shown in FIG. 5 that state that when the club head is in its normal address position, the dimensions of the head must be such that:
the distance from heel to toe is greater than the distance from face to back;
the distance from heel to toe is less than or equal to 7 inches (177.8 mm);
the distance from heel to toe of the face is at least two thirds of that from face to back;
the distance from heel to toe of the face is at least half that from heel to toe of the head; and
the distance from the sole to top of the head is less than or equal to 2.5 inches (63.5 mm).

For traditionally shaped heads, these dimensions will be measured on horizontal lines between vertical projections of the outermost points of the heel and the toe of the head, the heel and the toe of the face, the face and the back, and on vertical lines between the horizontal projections of the outermost points of the sole and the top of the head.

In respect of the striking face of the club head it must have only one striking face, except that a putter may have two such faces if their characteristics are the same, and they are opposite each other. In general the face of the club must be hard and rigid and must not impart significantly more or less spin to the ball than a standard steel face, although some exceptions may be made for putters. Except for such markings as listed below, the club face must be smooth and must not have any degree of concavity, and shall have a surface roughness within the area where impact is intended (the “impact area”) must not exceed that of decorative sandblasting, or of fine milling. The whole of the impact area must be of the same material (exceptions may be made for club heads made of wood). If a club head has grooves in the impact area they must meet the following specifications:
grooves must be straight and parallel, have a plain, symmetrical cross-section and have sides which do not converge, and have width, spacing and cross-section that is consistent throughout the impact area;
the width (W) of each groove must not exceed 0.035 inches (0.9 mm);
the distance between edges of adjacent grooves (S) must not be less than three times the width of the grooves, and not less than 0.075 inches (1.905 mm);
the depth of each groove must not exceed 0.020 inches (0.508 mm);
for clubs other than driving clubs, the cross-sectional area (A) of a groove divided by the groove pitch (W+S) must not exceed 0.0030 square inches per inch (0.0762 mm2/mm); and
grooves must not have sharp edges or raised lips.

If a club head has punch marks then they must meet the following specifications:
the maximum dimension of any punch mark must not exceed 0.075 inches (1.905 mm);
the distance between adjacent punch marks (or between punch marks and grooves) must not be less than 0.168 inches (4.27 mm), measured from center to center;
the depth of any punch mark must not exceed 0.040 inches (1.02 mm); and
punch marks must not have sharp edges or raised lips.

The center of the impact area of the club head, unless the club head is wood with an impact area made of a material of hardness less than metal, may be indicated by a design within the boundary of a square whose sides are 0.375 inches (9.53 mm) in length. Such a design must not unduly influence the movement of the ball on top of which decorative markings are permitted outside the impact area.

Accordingly, a designer seeking to design a golf club and/or golf club head that improves an aspect of play for a golfer, such as driving range, must comply with all the above features and others that have not been reproduced here. They must also consider the design of the golf ball itself as it is the combination of the two in conjunction with the golfer that determines ultimately the performance achieved.

Considering the golf ball then like the golf club it must not be substantially different from the traditional and customary form and make. The weight of the ball must not be greater than 1.620 ounces avoirdupois (45.93 gm), and the diameter of the ball must not be less than 1.680 inches (42.67 mm) at a temperature of 23±1° C. The golf ball must not be designed, manufactured or intentionally modified to have properties which differ from those of a spherically symmetrical ball. Further, the golf ball shall not have an initial velocity that exceeds the specified limit when measured on standard test apparatus approved by the USGA. Likewise the combined carry and roll of the golf ball, when tested on apparatus approved by the USGA, must not exceed the maximum distance specified when tested under conditions set forth in the Overall Distance Standard for golf balls.

If that was not enough, these rules are subjected to ongoing amendment and revision. As of 2011, these established that the initial velocity shall not be greater than 250 feet (75 m) per second, with a tolerance of +2%, and that the overall distance standard shall not cover an average distance in carry and roll exceeding 280 yards (84 m), with a tolerance of +6%.

Accordingly, the rules for both golf clubs and golf balls establish a design space within which designers operate in establishing every year the new designs that are marketed with promises of improved performance for the average golfer. These improvements may include, for example, the size of the sweet spot, the spin imparted to the golf ball, and the distance they can attain with their tee-shot. In recent years significant attention has been given to swing weight and counter-balance. The former is a measure of the total club head feel, and is used in order to achieve continuity amongst clubs for golfer and the latter is a measure of the location of the balance point of a golf club between the head and the grip.

Considering swing weight then low lofted irons start off lightest in weight, for example a 3-iron head may weigh 240 g, and because they have longer shafts give the feeling of high weight to the golfer due to the leverage effect of this longer shaft. The higher the iron number the heavier the club head, for example a pitching wedge may weigh 290 g, because their shorter shafts require a heavier club head in order to give the same relative feel for the golfer. Accordingly, golf club designers have provided golfers with means to adjust the weight of the golf club therefore over a small range in order to adjust the weight and thereby the feel to the golfer. Amongst these techniques are adding multiple weights into a chamber in the golf club head such as taught by Nygren in U.S. Pat. No. 4,076,254 entitled “Golf Club with Low Density and High Inertia Head”, depicted in FIG. 1, and adding different weights into the sole of the club head as taught by Chen in U.S. Patent Application 2003/0,162,608 entitled “Structure of a Golf Club Head”, depicted in FIG. 2. Likewise Duclos in U.S. Pat. No. 5,176,383 teaches to adding a weight within the body of a golf club head rather than at the back of the golf club, as depicted in FIG. 3.

Beach et al in U.S. Patent Application 2002/0,160,854 entitled “High Inertia Golf Club Head”, depicted in FIG. 4, teaches to adding weights into the base of the golf club head to adjust the inertia of the golf club head about an axis parallel to the ground. Beach also teaches that golfers prefer a driver golf club to have a total mass less than 250 grams, more preferably a total mass less than 230 grams and most preferably a mass less than 210 grams. Beach teaching that a lighter club head being preferred because it reduces the swing weight of the golf club but has less performance weight available to increase the moment of inertia of the club head.

Beach teaches that the structural members of the golf club head, i.e. the outer shell and the strike plate, typically have mass approximately 60%-90% of the total mass of the club head. The remaining 40%-10%, that constitutes the performance mass, is in the weight plugs of the invention taught by Beach. Typically within the prior art relating to weight golf club manufacturers have searched for ways to best distribute the performance weight so as to improve club head performance and have attempted to position most of the performance mass along the perimeter of the club head so as to increase the inertia of the club head.

Such perimeter weighting increases the inertia of the club head about the vertical axis and tends to make the club head more resistant to twisting during off-center hits but represents an inefficient use of the performance mass. Exceptions to the general trend of heel/toe weighting include Tseng in U.S. Pat. No. 6,620,053 entitled “Golf Club” teaches to inserting a weight into the shaft of the golf club rather than adjusting the weight of the club head itself, depicted in FIG. 5

However, if we consider a golf ball as a simple spherical object, without dimples and other aerodynamic effects such as drag and wind are neglected, then the trajectory calculation is really very simple. For any given time (t) the distance traveled (x component) is given by Equation (1):

x(t)=(Vₒ cos(m))t (1)

and the height (y component) at any given time (t) is given by Equation (2):

y(t)=(Vₒ sin(m))−(gt²/2) (2)

where Vₒ is the initial velocity of the golf ball, g is gravitational acceleration 9.8 m/s/s, and m is the launch angle in radians.

However, this simplistic trajectory is impacted by other factors such as the Magnus effect that defines the lift generated by a spinning dimpled golf ball in flight. When a lofted club strikes the ball properly, the ball will tend to travel or roll up the clubface before it is launched. This causes the ball to anti-clockwise spin at a rate governed by the speed, loft and surface friction of the club head face at impact. Typical ball spin-rates are:
3,600 rpm—hit with a 10° driver (8° launch angle) at a velocity of 134 mph
7,200 rpm—hit with a 5 iron (23° launch angle) at a velocity of 105 mph
10,800 rpm—hit with a 9 iron (45° launch angle) at a velocity of 90 mph

The Magnus effect can be estimated by Equation (3):

F_{L}(dvr⁴aᵥ2di²)(2r) (3)

where d is the density of air, v is the velocity of the golf ball, r is the golf ball radius, and aᵥ is the angular velocity in radians per second. Additionally, we have to consider air drag and wind force, these being given by Equations (4) and 5 below:

F_{w}=−C_{w}V_{w} (4)

F_{d}=−C_{d}Vₓ−C_{d}Vₓ−C_{d}V_{z} (5)

where C_{d,w} are the drag coefficients, V_{x,y,z} are the components of the velocity in the x, y, and z directions, and V_{w} is the wind velocity.

As such it is evident that the flight of the golf ball initially is determined by the velocity imparted in the strike from the golf club, coupled to with the lift angle and spin before loss of momentum and reduced spin rate from air resistance cause the golf ball to start dropping. As spin rate is additionally dependent upon loft angle of the golf club and its velocity at impact the initial velocity of the golf ball is critical to a golfer achieving distance with their strokes.

When the clubface of the golf club collides with the golf ball its total contact time is only approximately 0.0005 seconds but the peak force applied to the ball can be as high as 4000 pounds that actually compresses the golf ball at impact. The initial velocity of the golf ball after impact may be approximated by Equation (6) below:

V_{ball}=(V_{club} Coeffᵣₑₛₜ)/(1+(m_{ball}/m_{club})) (6)

where V_{club} is the velocity of golf club head at impact, Coeffᵣₑₛₜ is the coefficient of restitution that accounts for the momentum loss and the fraction of the energy into a collision that a “collision” returns, m_{ball} is the mass of the ball, and m_{club} is the mass of the club. Including the loft of the clubface results in Equation (7) wherein:

V_{ball}^{loft}=cos(loft)² sin(90−loft)V_{ball} (7)

where loft is the loft angle of the club.

The coefficient of restitution for a typical golf ball is 1.67 and 45 g. Accordingly, for the golfer they have two ways to influence the initial velocity of the golf ball, and hence the distance for a specific club. The first is by increasing V_{club}, the velocity of the golf club at impact, and secondly through using a heavier club, thereby increasing m_{club}. However, generally for an individual swinging a heavier club leads to a reduction in the velocity of the club.

However, as the mass of the club head increases there is an increased tendency for the club head to twist the golf club in the golfer's hands such that the golf club face strikes the ball at an angle. Hitting the ball with what is known as an “open club-face” and a club-path from out to in will cause the ball to spin from left to right. The ball's flight will then curve to the right or “Slice.” Conversely, hitting the ball with a “closed club-face” and a club-path from in to out will cause the ball to spin from right to left. The ball's flight will then curve to the left or “Hook”.

Equation (6) is derived from the considerations of force, kinetic energy and momentum of the golf club. As the swing progresses, the golfer applies more and more force to the golf club head causing it to accelerate and so increase its speed. Accordingly, when a golfer swings for a long drive, the goal is to accelerate the club head so that it impacts the ball at just the right point, going in just the right direction, and moving as quickly as possible. To do so, the golfer exerts force with his or her arms on the shaft of the golf club, which in turn exerts force on the golf club head. This situation may be approximated as a double pendulum wherein the arms, pivoting at the shoulders, roughly behave as a first pendulum, and the hands, grip, and shaft, pivoting at the wrists, behave as a second pendulum attached at the end of the first. For a well-timed drive, at the moment of impact the upper pendulum, i.e. the arms, is swinging very rapidly about its pivot point, and, at the same moment, the club is swinging very rapidly around its pivot point.

During this rapid motion of the swing the golfer must also control the orientation of the golf club with the intention of hitting the golf club squarely, to avoid hook and slice, and vertical position to avoid what are known as thick shots, the club is hitting the lower portion of the ball primarily, and thin shots, primarily hitting the upper portion of the ball. Overall therefore golf is a very challenging game, mainly due to control of the club while swinging and at impact. Accordingly, if you can swing the golf club a shorter distance and/or at a slower speed you will have more control and a better result, one of the biggest challenges for recreational golfers is trying to increase club head speed and still maintain control, yet golf club manufacturers are telling golfers that higher club head speed is required for a better game. To achieve this requires the golfer to have increased flexibility, so the swing arc is longer, increased strength so they can accelerate the club head faster, which is almost impossible to achieve for “regular” players who represent the vast majority of golfers globally.

Accordingly, with a heavier club a golfer can utilize a shorter swing arc and/or a shorter shaft, giving further control, with a lower club head speed and achieve a significant length drive. This is something “regular” golfers will find relatively easy to do as opposed to fundamentally adjusting their physique, coordination etc.

Accordingly, it would be beneficial to increase the mass of the golf club without imparting a corresponding reduction in the swing velocity thereby allowing the golfer to achieve an increased distance in their game. It would be further beneficial for the additional mass to be added in a manner that reduces the tendency for the golfers swing to adjust resulting in increased hook or slice. As such the additional mass added to a driver may, according to embodiments of the invention, be compensated by the adjustment in the balance of the golf club and allowing for the additional mass to be added non-uniformly to the golf club head.

### SUMMARY OF THE INVENTION

It is an object of the present invention to

In accordance with an embodiment of the invention there is provided a device comprising providing a golf club head, providing at least one predetermined region of a plurality of regions within the golf club head, and selectively adding to the at least one predetermined region a predetermined mass of a material.

In accordance with an embodiment of the invention there is provided a method comprising:
providing a golf club head having a predetermined weight, a first predetermined distribution of mass between a front strike face of the golf club head and a rear face of the golf club head, and a second predetermined distribution of mass between a first side of the golf club head positioned closer relative to a user when in use and a second side golf club head positioned away from the user when in use;
providing a shaft for attachment to the hosel, the shaft being attached at a first distal end;
providing at the second other distal end of the shaft a first predetermined weight at a first predetermined location; and
providing at the second other distal end of the shaft a second predetermined weight at a second predetermined location.

In accordance with an embodiment of the invention there is provided a method comprising:
providing a first predetermined portion of a golf club head comprising at least one first recess of a plurality of first recesses;
providing a second predetermined portion of a golf club head comprising a hosel and at least one second recess of a plurality of second recesses;
providing a third predetermined portion of a golf club comprising at least a first face, the first face for mating to the first predetermined portion of the golf club head and having a third recess positioned to align with each first recess of the plurality of first recesses;
providing at least a plug of a plurality of plugs, each plug comprising a first predetermined portion having a geometry compatible to fitting into a first recess in the first predetermined portion of a golf club head and a second predetermined portion having a geometry compatible to fitting into a second recess in the second predetermined portion of a golf club head, wherein
each plug is comprised predominantly of at least a material having a density significantly higher than the materials that form each of the first and second predetermined portions of the golf club head.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a golf weighting technique according to the prior art of Nygren in U.S. Pat. No. 4,076,254;

FIG. 2 depicts a golf weighting technique according to the prior art of Chen in U.S. Patent Application 2003/0,162,608;

FIG. 3 depicts a golf weighting technique according to the prior art of Duclos in U.S. Pat. No. 5,176,383;

FIG. 4 depicts a golf weighting technique according to the prior art of Beach in U.S. Patent Application 2002/0,160,854;

FIG. 5 depicts a golf weighting technique according to the prior art of Tseng in U.S. Pat. No. 6,620,053;

FIG. 6A depicts a golf weighting technique according to an embodiment of the invention;

FIG. 6B depicts a golf weighting technique according to an embodiment of the invention;

FIG. 7 depicts a golf weighting technique according to an embodiment of the invention;

FIG. 8 depicts a golf weighting technique according to an embodiment of the invention;

FIG. 9 depicts a golf weighting technique according to an embodiment of the invention;

FIG. 10 depicts a golf weighting technique according to an embodiment of the invention;

FIG. 11 depicts a golf weighting technique according to an embodiment of the invention;

FIG. 12 depicts a technique for providing a controlled hard surface to a golf club body formed from a high density metal;

FIG. 13 depicts a technique for adjusting a golfer's feel for a golf club; and

FIG. 14 depicts a technique for adjusting a golfer's feel for a golf club.

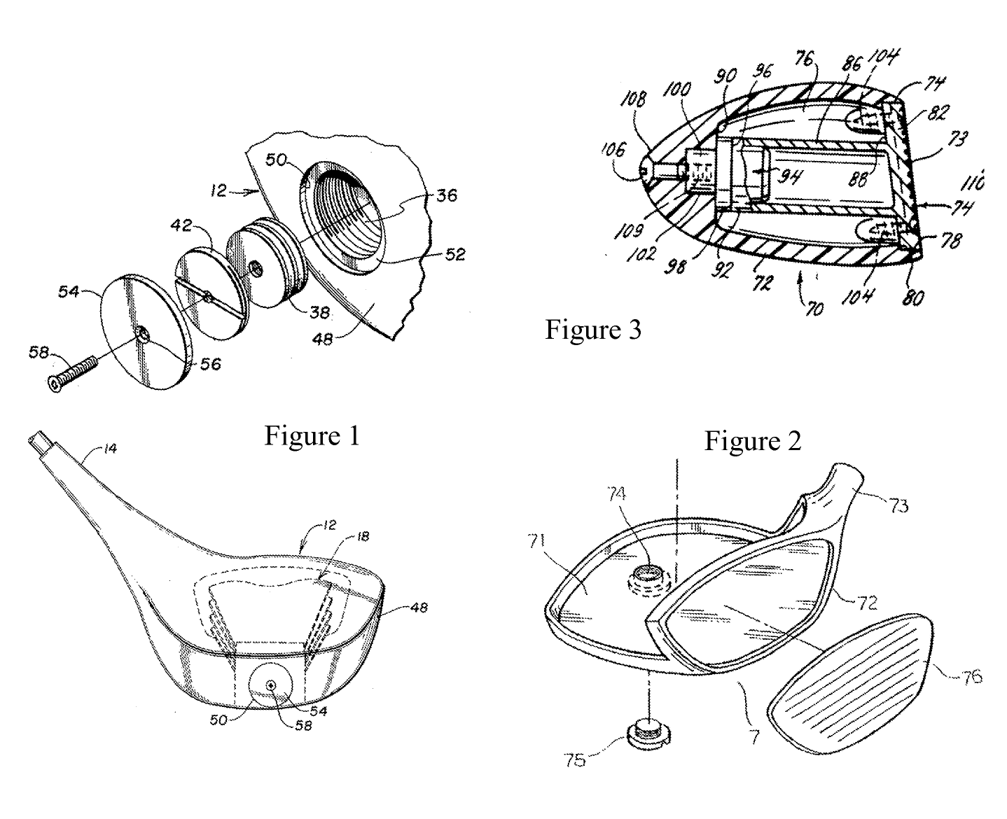

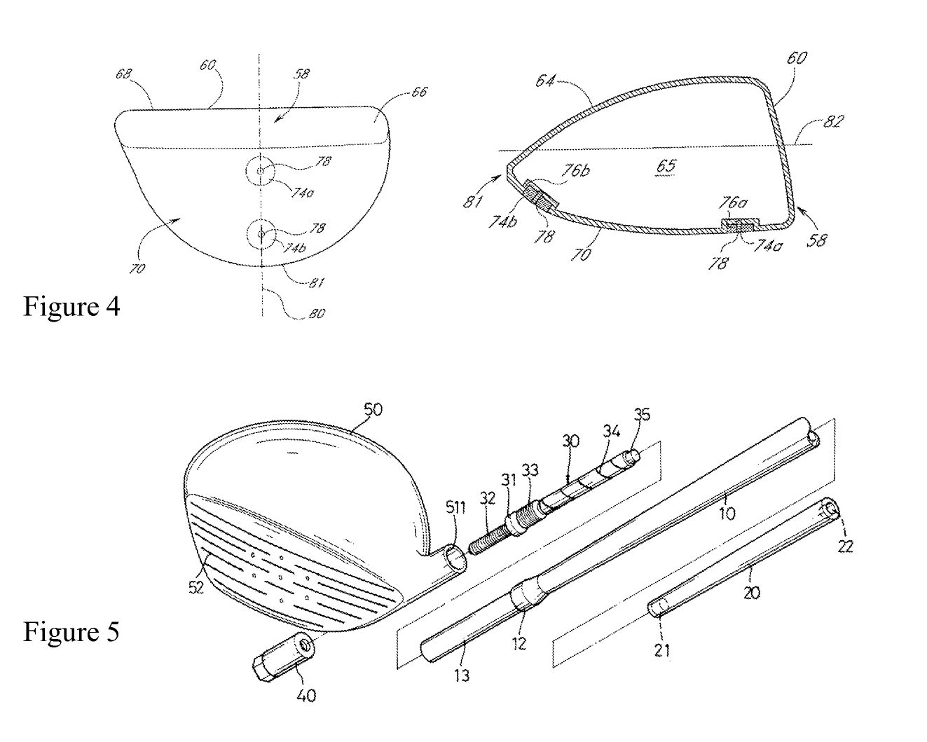

### DETAILED DESCRIPTION

The present invention is directed to golf clubs and more specifically to increasing the mass and adjusting the balance of said clubs.

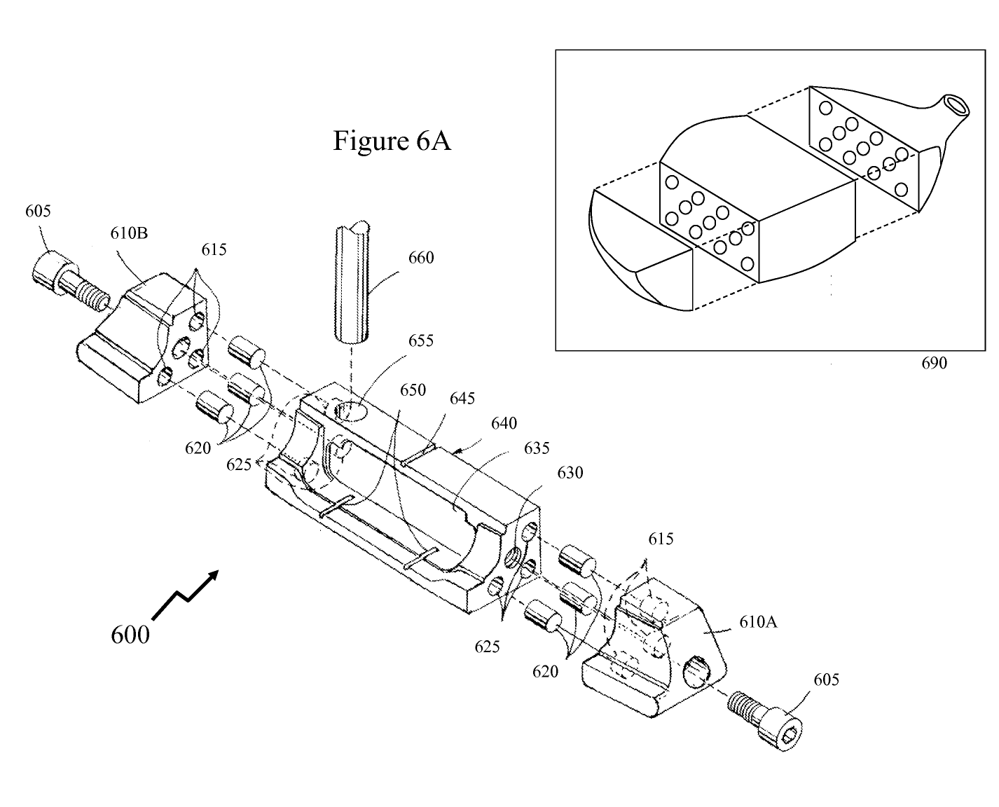

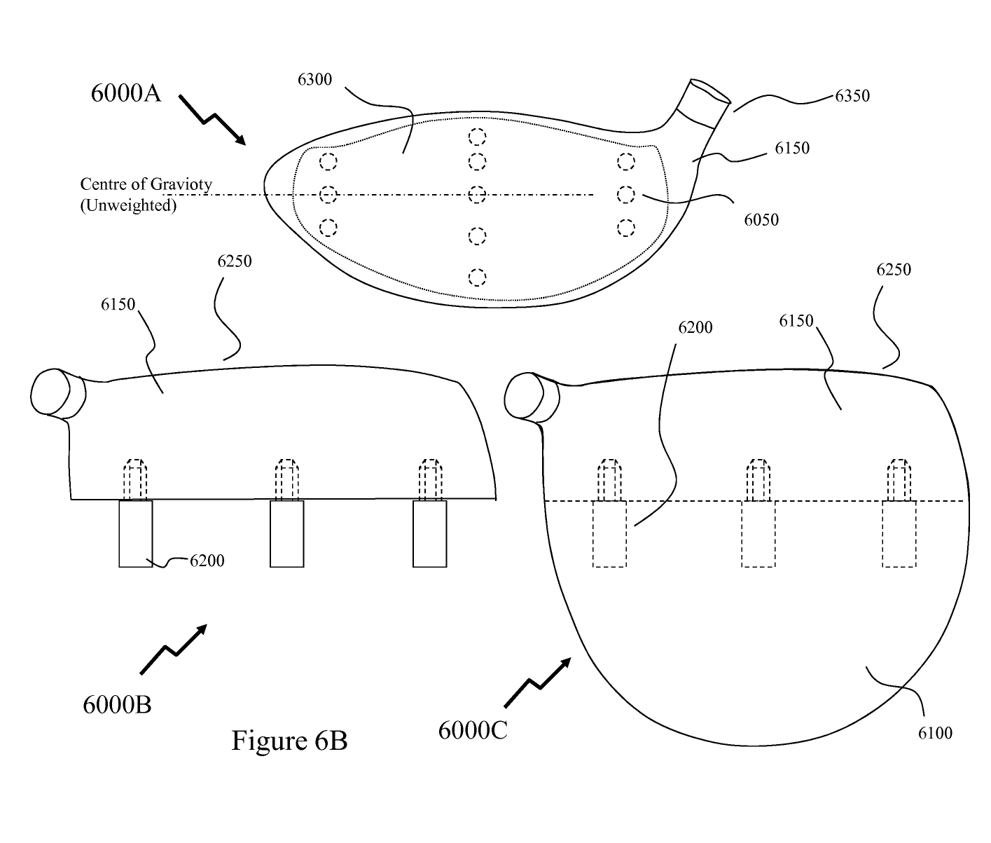

Referring to FIG. 6A there is shown a golf putter 600 according to an embodiment of the invention. Once assembled the golf putter 600 would appear to be composed of heel 610B, toe 610A, and body 640 connected to the shaft 660 via hosel 655. Disposed upon the visible exterior surfaces of body 640 are shaped recess 635, top sight line 645 and rear sight lines 650. Each of the heel 610B and toe 610A being attached to the body 640 via bolt 605 that screws into threaded recess 630.

Disposed within the faces of each of heel 610B and toe 610 are three first recesses 615. Likewise with the faces of body 640 abutting the heel 610B and toe 610A are three second recesses 625. Accordingly up to three slugs 620 can be inserted into the three second recesses 625 per face of the body 640 before the heel 610B and toe 610A are attached. It would therefore be evident that adding the slugs 620 to each side symmetrically increases the weight of the golf putter 600 whereas adding the slugs 620 in different combinations on either end of the golf putter 600 allows the weight to be increased but also distributed asymmetrically between heel 610B and toe 610A.

Considering a golf putter 600A formed from stainless steel then the density of the body 640, heel 610B and toe 610A would be approximately 8 g/cc, c.f. iron at 7.87 g/cc. For example 304 stainless steel has a density of 8.03 g/cc. Examples of materials for increasing the mass of these elements individually, in combination, or in combination with the slugs 620 are listed below in Table 1.

TABLE 1
Density of Potential Weighting Materials for Golf Clubs

| | | Relative to 304 |
|---|---|---|
| Material | Density g/cc | Stainless Steel |
| Tin | 7.300 | 0.91 |
| Copper | 8.940 | 1.11 |
| Silver | 10.490 | 1.31 |
| Lead | 11.340 | 1.41 |
| Mercury | 13.593 | 1.69 |
| Tungsten carbide | 15.800 | 1.97 |
| Tungsten | 19.300 | 2.40 |
| Platinum | 21.400 | 2.67 |

Optionally, each of heel 610B and 610A may be formed from a material of increased density along with the slugs 620 or they may be formed from different materials to each other and/or the slugs 620. Accordingly if each of the first and second recesses 615 and 625 are filled with a slug of tungsten, rather than air, the increased mass of the golf putter 600 is 3.55 g per slug 620. If all 6 slugs as shown are employed then the increased mass is 21.g. Making the slugs 620 2 cm long the increase in mass of the golf club is 42.6 g. Increasing the diameter of the slugs 620 to 1 cm results in an increase in mass of the golf putter 600 by up to 170 g. As such in terms of asymmetry the heel 610B in this instance may be imbalanced by up to 85 g against a golf putter 600g without slugs 620 bringing the center of gravity of the golf putter 600 closer to the shaft 660. Alternatively the toe 610A may be imbalanced by up to 85 g against a golf putter 600g without slugs 620 moving the center of gravity of the golf putter 600 further away from the shaft 660.

Whilst the approach shown in FIG. 6A was for a golf putter 600 the approach may be applied equally to a golf driver. However, as the golf driver is larger more slugs 620 may be inserted. Such a structure being shown by insert 690 in FIG. 6A wherein a driver is configured with 11 slug inserts for each interface between heel and toe and central body. It would be apparent to one skilled in the art that the pattern may for example be a row of 4 along the bottom of the club and a further 3 to the upper rear thereby removing any recesses closer to the face of the club.

Now referring to FIG. 6B there is depicted an alternate embodiment of the invention for weighting a golf club comprising a body 6150 and shell 6100. Referring initially to first view 6000A an elevation of the body 6150 is shown on the back surface 6300 away from the strike face 6250. Disposed within the back surface 6300 of the body 6150 are a plurality of threaded holes 6050 that are disposed to the heel, closer to the hosel 6350, centre, and toe, farther from the hosel 6350. The centre threaded holes 6050 being set into a pattern going from below an axis of the centre of gravity of the unweighted golf club to above the axis.

Referring to second view 6000B the body 6150 is shown in plan elevation with plug 6200 inserted into the threaded holes 6050. Accordingly it would be evident to one skilled in the art that the weighting of the golf club can be increased by adding plugs 6200 to the body 6150 and that the distribution of the weight may be adjusted either to the heel/toe of the golf club or above/below the centre of gravity of the unweighted golf club therein adjusting the location of this centre of gravity to for the user. Referring to third view 6000C the body 6150 is shown assembled with sell 6100 so that the golf club has an improved aerodynamic profile, aesthetic appearance, and compliance to golf rules. It would also be evident that by making the threaded holes 6050 with a small thread, such as M3 or 6-40 UNC for example, that the pitch of the threaded holes 6050 may be set small allowing multiple locations to be provided in the back surface 6300 even if all are not populated with larger plugs 6200. Alternatively the outer diameter of the plug may be close to the diameter of the threaded inserts allowing a higher density of plugs 6200 to be added to the golf club. Alternatively plugs of various dimensions and/or materials may be provided to provide adjustments in the incremental weight added to the club through each plug added.

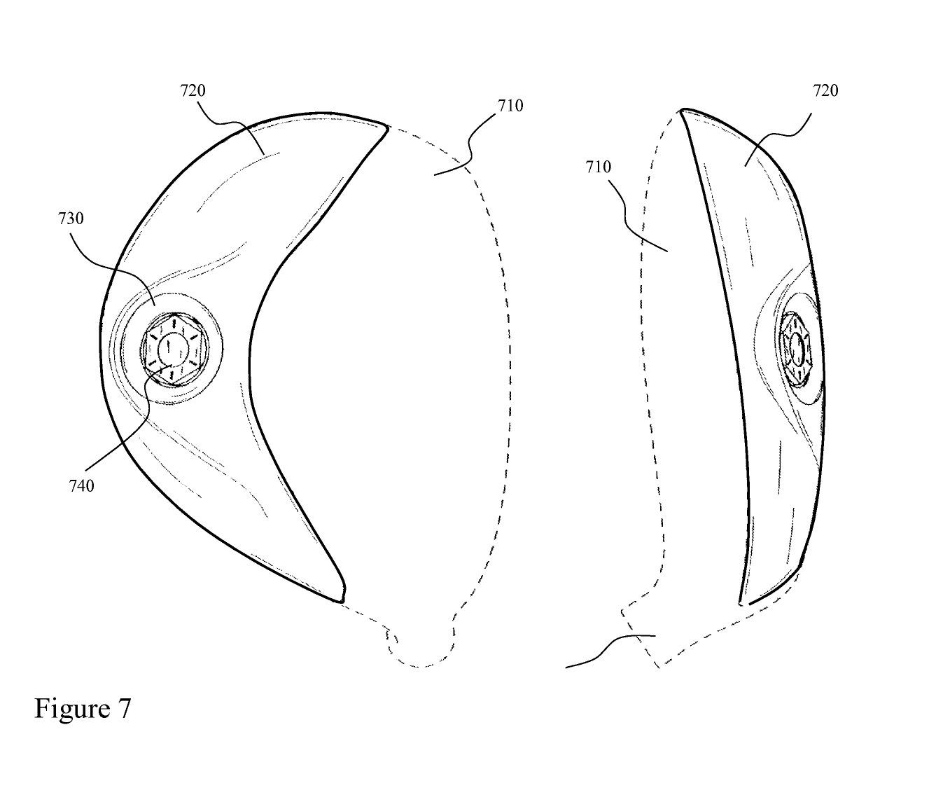

Referring to FIG. 7 there is depicted an alternate embodiment of the invention for weighting a metal golf club 700 wherein the weighting is applied to a hollow shell body 710 that has disposed within a chamber 720. Access to the chamber being obtained through an orifice 730 that is sealed with plug 740. Considering materials for golf club heads such as aluminum (melting point 660° C.), 304 stainless steel (1400° C.), and 316 stainless steel (melting point 1450° C.) then it would be evident to one skilled in the art that there is significant flexibility in selection of solder. Referring to Tables 2 and 3 the properties of common materials within solders and the resultant solders are summarized.

TABLE 2
Properties of Materials in Common Solders

| Material | Melting Point (° C.) | Density (g/cm-3) |
|---|---|---|
| Silver (Ag) | 1765 | 10.49 |
| Zinc (Zn) | 419.5 | 7.14 |
| Tin (Sn) | 231.9 | 5.79 (grey) |
| Lead (Pb) | 327.5 | 11.34 |
| Bismuth (Bi) | 271.5 | 9.78 |
| Antimony (Sb) | 630.6 | 6.70 |
| Indium | 156.6 | 7.31 |

TABLE 3
Properties of Some Common Solders

| Material | Melting Point (° C.) | Density (g/cm-3) |
|---|---|---|
| Pb98Sn2 | 316 | 11.5 |
| Pb75Sn25 | 183 | 9.95 |
| Sn50Pb50 | 183 | 8.56 |
| Bi52Pb32Sn14 | 96 | 9.64 |
| In50Sn50 | 118 | 6.54 |
| Sn50Zn50 | 199 | 6.19 |

Some solders, such as In50Sn50 have good wetting to ceramics allowing their use in conjunction with ceramic golf club bodies, such as putters and irons. Sn50Zn50 has good wetting to aluminum. As such the body of the golf club 710 may be heated or unheated and molten solder added into the chamber 720 to add weight to the club.

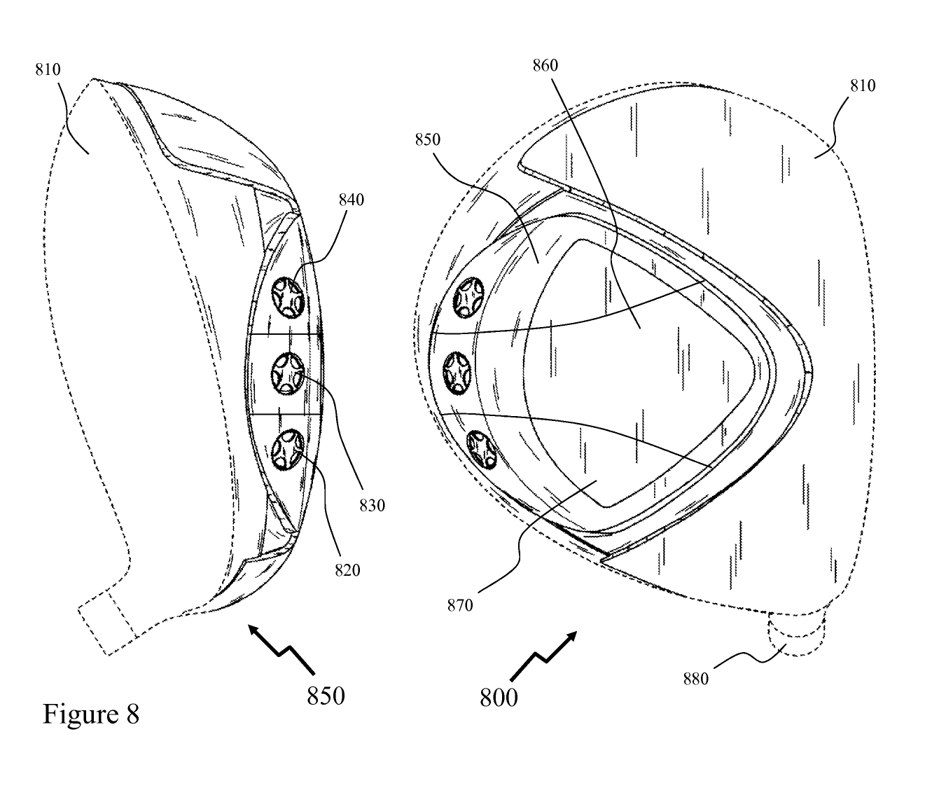

Referring to FIG. 8 an alternate embodiment is depicted in side elevation 800 and plan view 850 respectively. As shown in side elevation 800 a golf club head 810 has three access points 820, 830 and 840 on the rear face. Referring to plan view 850 it can be seen that first access point 820 is coupled to first chamber 870, second access point 830 is coupled to second chamber 860, and third access point 840 is coupled to third chamber 850. Accordingly, not only can the weight of the golf club be increased significantly but the distribution of that weight can be adjusted between the centre and towards the heel/toe.

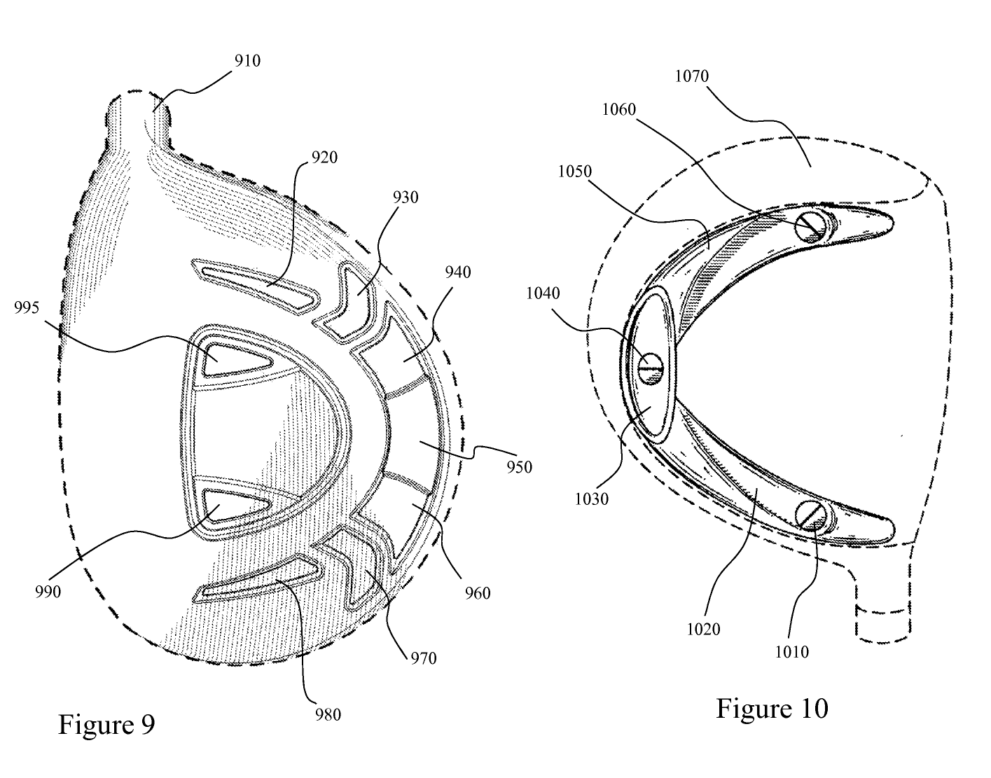

Now referring to FIG. 9 there is depicted wherein a golf club 910 has been patterned with multiple recesses 920 through 995 respectively that may be filled with low melting point alloy, i.e. a solder. Accordingly the multiple recesses 920 through 955 allow for a more complex adjustment in the distribution of weight and the total weight added. Optionally, a single base cover may be attached over the bottom of the club once the multiple recesses have been accessed for the addition of the low melting point alloy. Such a cover providing a cosmetic finish but also providing a smooth lower surface for improved aerodynamics.

Referring to FIG. 10 an alternate embodiment is presented wherein the main body of the golf club head 1070 has a recess, not shown for clarity formed within it. In the bottom of the recess are three threaded inserts, not shown for clarity, that accept first to third screws 1010, 1040 and 1060 respectively. Fitting into the recess are first insert 1020, second insert 1030, and third insert 1050. Accordingly if first to third inserts 1020, 1030, and 1050 are formed from a fibre reinforced polymer (FRP) then they will have a density of approximately 1.6-2.0 gcm⁻³ thereby offering a golf club head 1070 weight essentially determined by the body of the golf club head. However, if first to third inserts 1020, 1030, and 1050 are formed from tungsten then these will have a density of 19.3 gcm⁻³ thereby increasing the weight of the golf club head 1070. It would also be apparent to one skilled in the art that one, two or all three inserts may be changed from FRP to tungsten providing differing weights overall and differing weight distributions. Likewise third insert 1050 may be replaced with one from copper, density 8.94 gcm⁻³, whilst first and second inserts 1020 and 1030 are replaced with tungsten. In this manner the weight is increased but a distribution towards the heel is achieved. Alternatively each insert may be replaced by two inserts such that a thinner FRP insert and a thinner metallic insert are combined to provide weights that are increased but not as heavy as complete replacement of the insert(s).

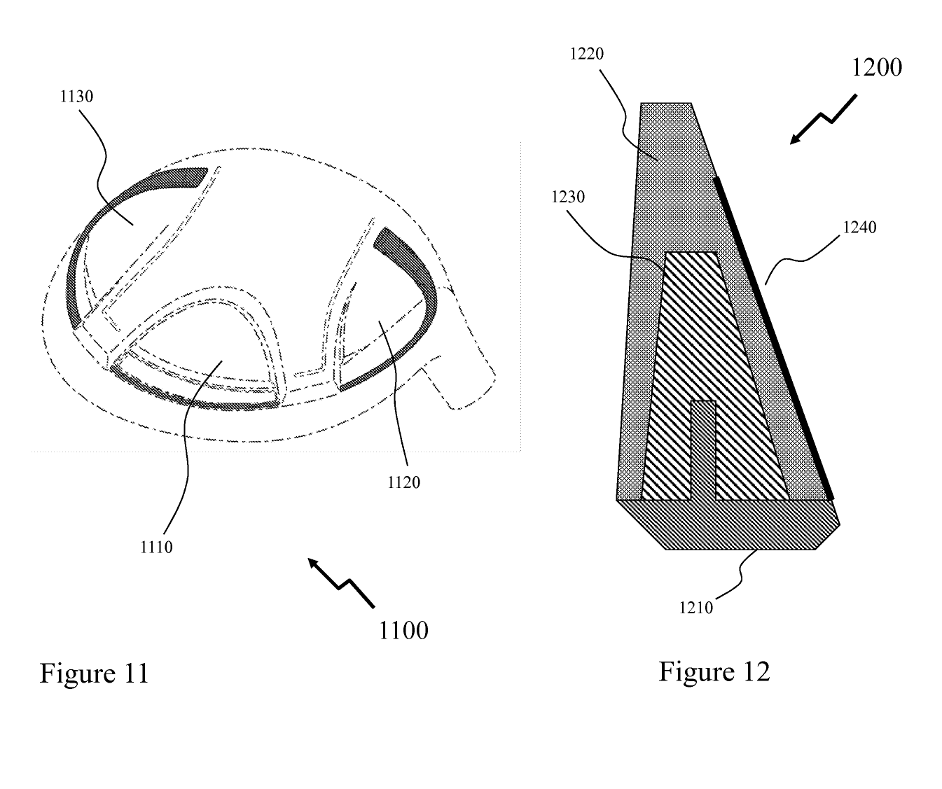

Referring to FIG. 11 there is shown another embodiment of a golf club head 1100 according to an embodiment of the invention. Within the preceding embodiments weight has been added to a lower weight club head. In FIG. 11 this is reversed wherein the golf club head 1100 is initially formed at the maximum mass, for example through the use of a thick tungsten sole plate. Subsequently, material is then selectively removed through post-processing, for example, milling such that material is removed from predetermined areas 1110 to 1130 respectively. Such post-processing reduces the weight and also allows the weight distribution to be modified front to back or heel to toe. It would be apparent that complex or simple patterns of material removal might be considered without departing from the scope of the invention.

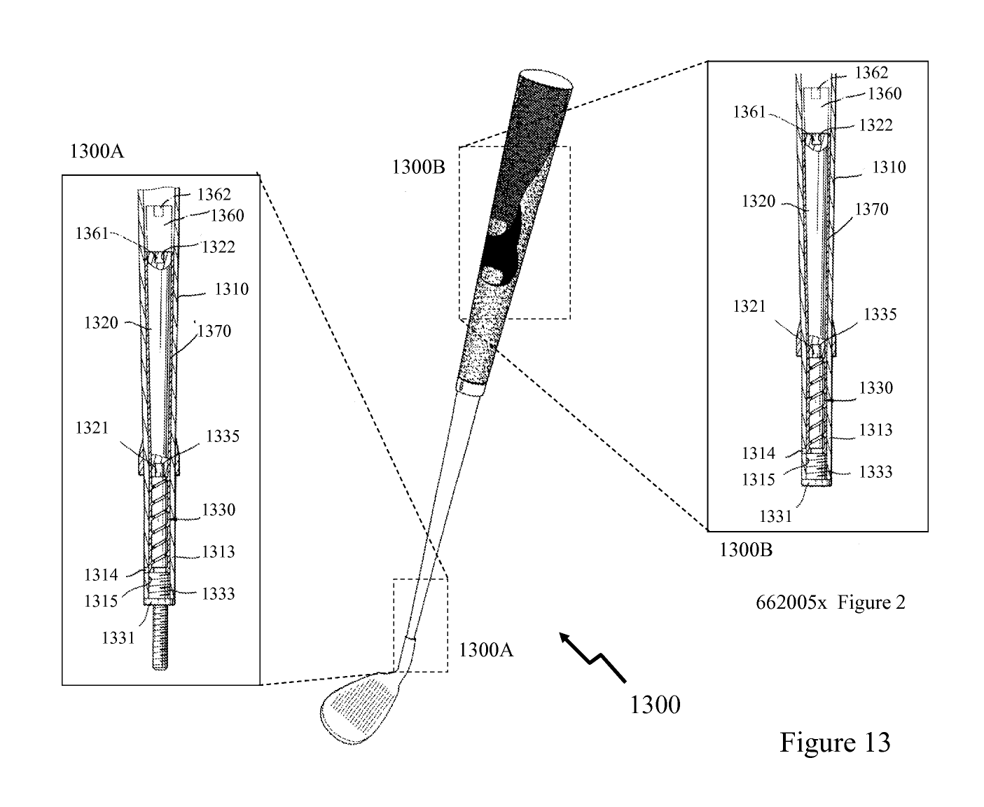

Referring to FIG. 12 an alternate structure for a golf club head 1200 is depicted comprising a base element 1210, body element 1220 and core 1230. Body element 1220 for example may be formed from a glass/carbon/basalt fiber FRP or a ceramic such as alumina, having a typical density of 4 gcm⁻³, or tungsten carbide, density 15.8 gcm⁻³. Core 1230 may be formed from a material such as tungsten that is then selectively post-processed, such as by machining to remove material. The core 1230 being bonded to the body element 1220. Formed upon the face of golf club head 1200 is an impact area 1240, formed for example by the selective deposition of tungsten, diamond or other material to form the impact surface.

Alternatively, core 1230 may be formed from materials with varying densities such as FRP, aluminum, and tungsten to provide a series of increasing weights for the overall golf club head 1220. The body element 1220 may also be formed from a progressive sequence of materials. In the case that the body element 1220 for example is formed from tungsten then the impact area 1240 may be formed from tungsten carbide through the carbonization of tungsten.

As discussed supra the “feel” of a golf club to a golfer can be adjusted through the position of the balance point. In the embodiments presented supra the focus has been to increased golf club weight. Considering golf club 1300 then this is achieved together with an adjustment in “feel” or swing weight through the provisioning of a counter-balancing weight in the grip portion 1300B of the club. Accordingly, there is shown in the hosel-shaft region 1300A a first in-shaft weight structure and in the grip portion 1300B a second in-shaft weight structure. For simplicity these are depicted as being the same. Accordingly a hollow shaft 1310 has a tapered inner channel, not identified for clarity, receiving a bar-like weight 1320. The weight 1320, being shaped to mate with the inner channel. The hollow shaft 1310 further has a threaded inner periphery 1315 defined at its thin end 1313, and the threaded intermediate section 1333 of the structure 1330 is engaged with the threaded inner periphery 1315 in such a way that its annular stop 1331 abuts the thin end 1313 of the shaft 1310 and its boss 1335 fits in the recess 1321 of the weight 1320. As a result, the structure 1330 is connected to the shaft 1310.

A secondary weight 1360 may be additionally received in the channel of the hollow shaft 1310, if necessary. The secondary weight 1360 being located adjacent to an end of the weight 1320 opposed to the structure 1330, and has a boss 1361 configured to fit in the recess 1322 of the weight 1320. The secondary weight 1360 may further have a recess 1362 for the addition of a third weight. The hosel 1330 and the weight 1320 or weights 1320, 1360 may be joined to the shaft 1310 through a resin 1370, which may also be applied to the recesses 1321, 1322 and the bosses 1335, 1361. In this case, the hollow shaft 1310 has a vent 1314 defined therein, in order to let air into the hollow shaft 1310 to help consolidation of the resin 1370, as well as to lead surplus resin 1370 out of the hollow shaft 1310.

Accordingly through the combination of the weight 1320 or weights 1320, 1360 the overall weight of the golf club 1300 can be adjusted but also the “feel” adjusted by adding more counter-balancing weight to the grip of the golf club 1300.

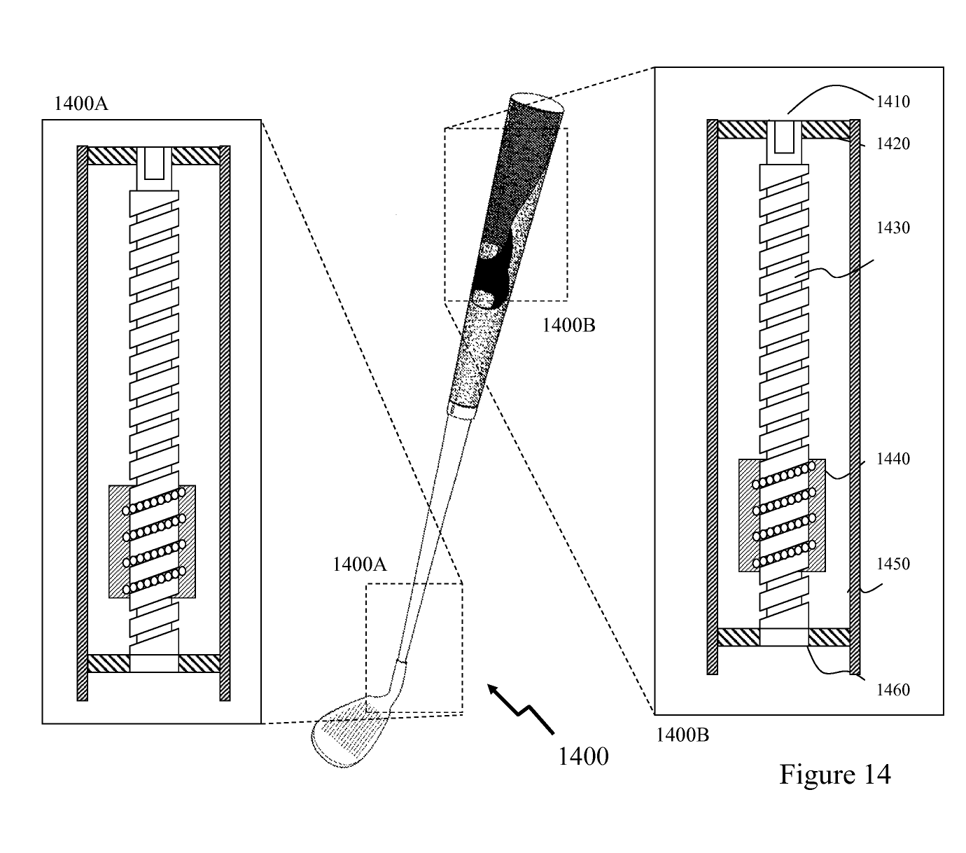

Referring to FIG. 14 there is shown an alternate golf club 1400 providing increased weight, counter-balancing but with increased adjustment. Accordingly in each of the hosel attachment region 1400A and grip region 1400B of the golf club 1400 an adjustable weight structure is provided. As shown the shaft 1450 has disposed a first plate 1420 and a second plate 1460. Running between first plate 1410 and second plate 1460 is lead screw 1430 that has a key recess 1410 at the end with first plate 1420. Lead screw 1430 being free to rotate relative to first and second plates 1420 and 1460 respectively. Attached to the lead screw 1430 is weight 1440 such that rotation of the lead screw 1430 through the use of the key in key recess 1410 moves the weight vertically along the length of the lead screw 1430. Accordingly, the weight(s) can be adjusted vertically with respect to the golf club 1400. Optionally with a long lead screw multiple weights 1440 may be added to one or both structures. As such the golf club weight can be increased; the “feel” adjusted through counter-balancing and the golf club 1400 set to each individual gofer's preferred set-up.

It would be evident that the embodiments of the invention above may be employed discretely or in combination. For example weighting the golf club head with an asymmetric weighting and counter-balancing through a weight in the grip of the golf club.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
providing a golf club head;
providing at least one predetermined region of a plurality of regions within the golf club head; and
selectively adding to the at least one predetermined region a predetermined mass of a material.

2. The method according to claim 1 wherein,
providing the plurality of regions comprises providing at least one of a recess, a chamber, and a groove.

3. The method according to claim 1 wherein,
providing the predetermined mass of a material comprises applying a predetermined volume of the material in molten form and allowing the material to solidify.

4. The method according to claim 1 further comprising;
selectively adding predetermined masses of material to a predetermined sub-set of the plurality of regions.

5. The method according to claim 1 further comprising;
providing a shaft to which the golf club head is attached at a first distal end;
providing at the second other distal end of the shaft a predetermined weight at a predetermined location.

6. The method according to claim 1 further comprising;
providing a shaft to which the golf club head is attached at a first distal end;
providing at the second other distal end of the shaft a first predetermined weight at a first predetermined location; and
providing at the second other distal end of the shaft a second predetermined weight at a second predetermined location.

7. A method further comprising;
providing a golf club head having a predetermined weight, a first predetermined distribution of mass between a front strike face of the golf club head and a rear face of the golf club head, and a second predetermined distribution of mass between a first side of the golf club head positioned closer relative to a user when in use and a second side golf club head positioned away from the user when in use;
providing a shaft for attachment to the hosel, the shaft being attached at a first distal end;
providing at the second other distal end of the shaft a first predetermined weight at a first predetermined location; and
providing at the second other distal end of the shaft a second predetermined weight at a second predetermined location.

8. The method according to claim 7 wherein;
providing the golf club head having a predetermined weight and first and second predetermined distributions of mass comprises:
providing at least one predetermined region of a plurality of regions as part of the golf club head;
selectively adding to the at least one predetermined region a predetermined mass of a material.

9. The method according to claim 8 wherein,
at least one of providing the plurality of regions comprises providing at least one of a recess, a chamber, and a groove and providing the predetermined mass of a material comprises applying a predetermined volume of the material in molten form and allowing the material to solidify.

10. The method according to claim 9 wherein,
at least one of providing the plurality of regions comprises providing at least one of a recess, a chamber, and a groove and providing the predetermined mass of a material comprises attaching a predetermined profile of a material within the at least one region of the plurality of regions, the predetermined profile substantially corresponding to the profile of the region.

11. A method comprising:
providing a first predetermined portion of a golf club head comprising at least one first recess of a plurality of first recesses;
providing a second predetermined portion of a golf club head comprising a hosel and at least one second recess of a plurality of second recesses;
providing a third predetermined portion of a golf club comprising at least a first face, the first face for mating to the first predetermined portion of the golf club head and having a third recess positioned to align with each first recess of the plurality of first recesses;
providing at least a plug of a plurality of plugs, each plug comprising a first predetermined portion having a geometry compatible to fitting into a first recess in the first predetermined portion of a golf club head and a second predetermined portion having a geometry compatible to fitting into a second recess in the second predetermined portion of a golf club head, wherein
each plug is comprised predominantly of at least a material having a density significantly higher than the materials that form each of the first and second predetermined portions of the golf club head.

12. The method according to claim 11 wherein,
the material is selected from the group comprising bismuth, zinc, vanadium, uranium, tungsten, titanium, tin, niobium, nickel, lead, iron indium, copper, chromium, niobium, brass, bronze, stainless steel, and stainless steel.
